(19) United States
(12) Patent Application Publication
(10) Pub. No.: US 2026/0211668 A1
(43) Pub. Date: Jul. 23, 2026

(54) SOFTWARE VERSION DEPENDENCY MANAGEMENT SYSTEM USING LARGE LANGUAGE MODEL

(71) Applicant: SAP SE, Walldorf (DE)

(72) Inventors: Sreenivasulu Gelle, San Ramon, CA (US); Alexander Ocher, San Jose, CA (US)

(21) Appl. No.: 19/034,373

(22) Filed: Jan. 22, 2025

(51) Int. Cl. G06F 8/71; G06F 40/295

(52) U.S. Cl. CPC G06F 8/71; G06F 40/295

(57) ABSTRACT

In an example embodiment, a large language model (LLM) is used to capture semantic relationships between entities so that machine learning techniques can be used to analyze patterns and relationships of entities and dependencies. This includes analyzing version requirements and dependencies among software products. The system is trained to recognize compatibility patterns and understand the impact of product upgrades on dependencies.

### TECHNICAL FIELD

This document generally relates to computer systems. More specifically, this document relates to use of a large language model for software version dependency management.

### BACKGROUND

Software version dependencies refer to the relationships between different versions of software components (libraries, frameworks, or applications) where one component relies on another. These dependencies can rely on a particular version of a software component in order for another software to function correctly.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system 100 for managing software versions in accordance with an example embodiment.

FIG. 2 is a flow diagram illustrating a method 200 of managing software product versions, in accordance with an example embodiment.

FIG. 3 is a block diagram illustrating an architecture of software for embedding searches, which can be installed on any one or more devices.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Effective management of software compatibilities is beneficial to the smooth functioning of enterprise systems. These systems rely on the seamless interaction of multiple software products, and identifying product incompatibilities can be a very challenging tasks, leading to issues that are difficult to troubleshoot. Additionally, these products are often supplied by various vendors who may not collaborate or provide compatibility information in a timely manner.

What is needed is the ability to assess the compatibility of all components within a system, monitor the availability of new versions, and perform dependency searches based on documented dependencies.

In an example embodiment, a large language model (LLM) is used to capture semantic relationships between entities so that machine learning techniques can be used to analyze patterns and relationships of entities and dependencies. This includes analyzing version requirements and dependencies among software products. The system is trained to recognize compatibility patterns and understand the impact of product upgrades on dependencies.

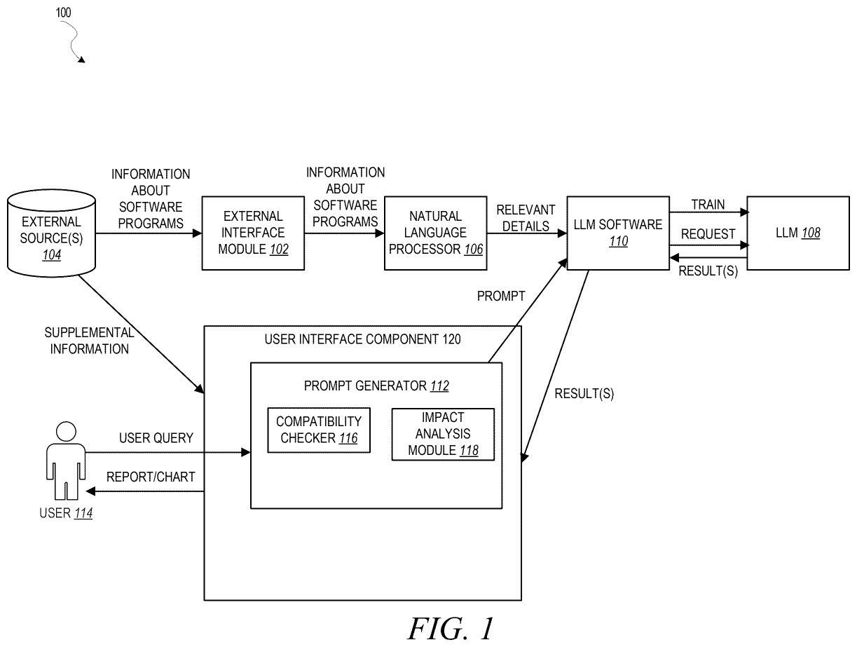

FIG. 1 is a block diagram illustrating a system 100 for managing software versions in accordance with an example embodiment. An external interface module 102 searches product documentation and checks for new versions of dependent products in external sources 104, such as product websites. It extracts information from those external sources 104 and feeds the information to a natural language processor 106 to identify the relevant details, such as product names, version numbers, release data, and compatibility information. This process can be performed at regular intervals or be triggered by events such as user requests or notifications.

The natural language processor 106 may perform one or more of many different types of natural language algorithms to determine the relevant details. In one example embodiment, the natural language processor 106 includes a Bidirectional Encoder Representation from a Transformers (BERT) model, to encode text portions into embeddings. BERT is a type of natural language processing (NLP) model based on the transformer architecture. BERT uses one or more transformer layer(s) within a neural network to encode the input sentence to an embedding. Each transformer layer is defined as follows:

$$TFLayer ( {h}^{n - 1} ) = FC ( MultiAttn ( {h}^{n - 1} ) ) ;$$

$$FC ( x ) = relu ( {xW}_{1} + {b}_{1} ) {W}_{2} + {b}_{2} ;$$

$$MultiAttn ( {h}^{n - 1} ) = concat ( {head}_{1} ( {h}^{n - 1} ) , … , {head}_{k} ( {h}^{n - 1} ) ) {W}^{O} ,$$

$${head}_{i} ( {h}^{n - 1} ) = soft max ( \frac{( {h}^{n - 1} {W}_{q}^{i} ) ( {h}^{n - 1} {W}_{k}^{i} )}{\sqrt{{d}_{k}}} ) ( {h}^{n - 1} {W}_{v}^{i} ) .$$

where hⁿ⁻¹ is the output of the previous transformer layer.

In another example embodiment, the natural language processor 106 includes a Word2Vec model. Word2Vec uses an embedder, which is a shallow, two-layer neural network trained to reconstruct linguistic contexts of words. Word2Vec takes as input a large corpus of text and produces a vector space, typically of several hundred dimensions, with each unique word in the corpus being assigned a corresponding vector in the space. Word vectors are positioned in the vector space such that words that share common contexts in the corpus are in close proximity to one another in the space.

In another example embodiment, a sentence similarity transformer model may be used in the natural language processor 106. A sentence similarity transformer model is a type of natural language processing model designed to measure the similarity between two sentences or pieces of text. It leverages transformer architecture, which has been highly successful in various natural language processing tasks. Transformer models are known for their ability to capture contextual information effectively and have been the foundation for many state-of-the-art NLP applications.

The goal of a sentence similarity transformer model is to determine how similar or related two sentences are, often by providing a similarity score or metric.

Data may be grabbed from a list of vendor product sites that provide software compatibility information and a raw data set of relevant information may be produced. This data may include, for example, a product availability matrix.

A product availability matrix is a tool or document used to provide an overview of the compatibility and availability of different software products, versions, or features across various environments and configurations. It helps organizations determine which versions of software are supported in specific scenarios, such as particular operating systems, hardware platforms, or cloud environments. The matrix typically includes details about the different software versions, the environments where the software can be deployed (such as operating systems, cloud platforms, or containerized environments), and which features or functionalities are supported in each version or environment.

Additionally, it outlines the support status of different versions, showing whether a product is actively supported, under extended support, or deprecated. It also provides information about how the software interacts with other related products or dependencies, like databases or third-party libraries. Furthermore, the matrix highlights the available deployment options, such as on-premises, cloud, or hybrid deployments.

This tool is particularly useful for planning software updates, ensuring that newer software versions are compatible with existing infrastructure, checking compatibility before installing or upgrading software, and assisting in decision-making about product support. For example, it can show whether a specific version of a software is supported on various operating systems like Windows or Linux, and whether it works with different cloud platforms or databases. Ultimately, the matrix helps organizations avoid issues related to unsupported configurations and simplifies the decision-making process regarding IT infrastructure and software deployments.

The raw data set is then formatted using a predefined format to include normalized product names, versions, compatibility with other products, operating system support, product support, and/or end-of-life information. The natural language processor 106 can then be fine-tuned using this formatted data set. the normalized software compatibility information from the natural language processor 106 can then be used as input to the LLM for fine-tuning.

Referring back to FIG. 1, the details extracted by the natural language processor 106 are used to train an LLM 108. The training itself may be performed by LLM software 110. The LLM 108 may be trained by feeding massive amounts of text data into the LLM, allowing it to learn patterns and relationships between words, enabling it to generate human-like text, translate languages, answer questions, and perform other complex language tasks. This process may involve an initial “pre-training” phase with unsupervised learning, followed by a “fine-tuning” stage where the model is further optimized for specific tasks using smaller data sets. As such, the training described in this disclosure could be considered to be part of the “fine-tuning” stage of training, where an earlier trained general LLM is fine-tuned, such as being fine-tuned into a domain-specific LLM.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance. The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model, although an implementation that specifically is used with a GPT model are be described.

Referring back to FIG. 1, a prompt generator 112 receives a query from a user 114 and generates a prompt to the LLM 108 via the LLM software 110. The query may be specified in various different ways, such as via text input, graphical user interface input, or a combination of both.

The prompt generator 112 may contain one or more specialized components for aid in constructing prompts based on certain types of queries. For example, a compatibility checker 116 may be specifically designed to aid in answering user queries about software compatibilities. An impact analysis module 118 may be specifically designed to aid in answering user queries about the impact of changes, such as whether upgrading certain software may cause other software to stop working or otherwise be negatively impacted.

The prompt generator 112 may otherwise be contained within a user interface component 120 that acts to receive the queries from the user 114 and also to take results obtained from the LLM 108, via the LLM software 110, and format them appropriately, such as by generating one or more reports/charts based on the results. More particularly, the prompt generated by the prompt generator 112 is passed to the LLM 108, via the LLM software 110. The LLM 108, having been fine-tuned/trained to understand the meaning of the information about the various software versions and dependencies, is able to provide specific results to the user interface component 120.

In some additional embodiments, the prompt generator 112 may use retrieval augmented generation (RAG) as part of the prompt generation process. RAG is a framework that combines traditional retrieval techniques with generative models to improve the quality of generated responses, particularly in tasks like question answering or conversational agents. In RAG, the process typically involves two main steps:
Retrieval: The system first retrieves relevant documents or pieces of information from a large database or knowledge base based on the input query. This can be performed using techniques like search algorithms or vector embeddings to find the most pertinent information.
Generation: After retrieving relevant information, a generative model (like an LLM) processes this data to produce a coherent and contextually appropriate response. The model can leverage the retrieved content to enhance its answers, making them more accurate and informative.

The combination allows the model to provide richer, more context-aware responses than it could generate from scratch, tapping into a larger body of knowledge while still being able to generate natural language responses. The responses may be based on specifically cohesive content.

The compatibility checker 116 and/or impact analysis module 118 act to take a user's question and rewrite it into a format appropriate for a prompt to the LLM 108. The compatibility checker 116 may, for example, take a product and a version as specified by the user and aid in generating a prompt for the LLM 108 to obtain an indication of compatible products and versions. Specifically, the compatibility checker 116 analyzes the user's natural language query to identify its intent and key entities. For example, it identifies keywords such as “compatibility,” “product versions,” “operating system support,” and “dependencies.” The compatibility checker 116 then extracts relevant information from the user's query using, for example named entity recognition (NER), to identify product names, versions, and operating systems mentioned in the query.

NER is a process in Natural Language Processing designed to identify and classify named entities in text, such as people, organizations, locations, dates, and other specific terms. It begins by breaking down the text into smaller units called tokens, typically words or phrases. Once the text is tokenized, the system often performs part-of-speech tagging to determine the grammatical role of each token, helping to identify entities more effectively.

NER then scans the tokens to locate named entities. After identifying these entities, the system classifies each one into predefined categories. The recognized entities are tagged with labels. Sometimes, additional post-processing is performed to resolve ambiguities, such as distinguishing between different meanings of the same word, or linking the entity to external knowledge sources.

NER uses different techniques, including rule-based systems that rely on predefined rules and dictionaries, statistical models like Hidden Markov Models (HMMs) or Conditional Random Fields (CRFs), and/or deep learning methods. Machine learning models, such as those based on Recurrent Neural Networks (RNNs) or Transformer-based models like BERT, can be used due to their ability to learn context from large amounts of data. These models are trained to recognize patterns in text, and can even be fine-tuned for specific tasks, such as NER.

The compatibility checker 116 then rewrites the user's query into a more structured and formal representation. It may rephrase the query to explicitly include the product names, versions, and other relevant details. For example, it may rewrite a query like “Is the current version of SAP Data Services compatible with AIX?” to “What version of AIX operating system is SAP Data Services 4.3 compatible with?”.

In some example embodiments, the compatibility checker 116 may make multiple requests, based on object-specific attributes, to ensure that all possible combinations are covered. For example, these attributes can be old/new OS for Data Services, BOE versions, OS for Business Object Enterprise, etc. The reason is that current Generative AI tools are not capable of joining several different queries together or doing a comparison between even two versions of the same product. For example, prompting ChatGPT with “What is the difference in supported OS versions between SAP Data Services 4.0 and 4.1?” produces incorrect information, such as:
Newer Windows Server Versions:
SAP Data Services 4.1 introduces support for Windows Server 2012 and Windows Server 2012 R2, which are not supported in version 4.0.
Windows Server 2003 support is dropped in 4.1.
   However, Windows Server 2003 was still supported in Data Services 4.1; please refer to the Product Availability Matrix.

The compatibility checker 116 can leverage additional domain-specific knowledge sources, such as databases, Application Program Interfaces (APIs), and other systems that provide detailed information about software product compatibility. The compatibility checker 116 can use this additional knowledge to enrich the rewritten query with specific details about supported operating systems, minimum requirements, or known compatibility issues. Also, CCM can provide suggestions and auto-complete user queries.

The impact analysis module 118 performs operations similar to the compatibility checker 116, but is more geared towards creating impact analysis and what-if scenarios. It displays results as a connected graph where nodes represent software components and edges represent dependencies. The users can interact with the graph, for example, by changing a node representing a software component; this action triggers additional prompts to the LLM 108, such as “What if Data Services 4.0 is downgraded from SP03 to SP01?” The LLM 108 processes these prompts and returns updated information, which is then updated in the dependency graph. Thus, the users can visualize, modify, and assess the impact of upgrades on connected software products.

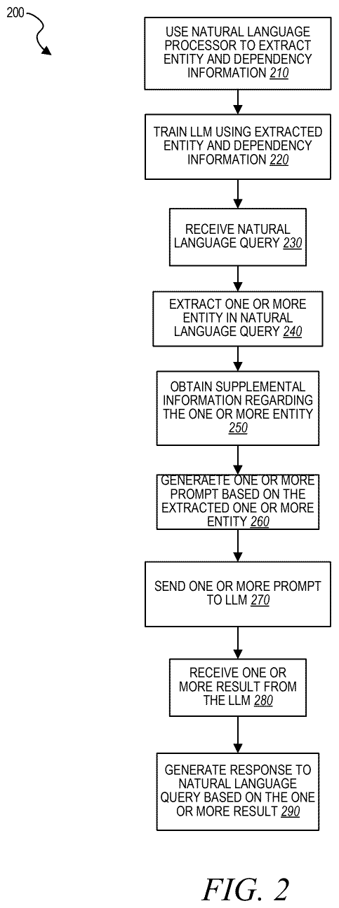

FIG. 2 is a flow diagram illustrating a method 200 of managing software product versions, in accordance with an example embodiment.

At operation 210, a natural language processor is used to extract entity and dependency information from data obtained from one or more external sources. The data pertains to software versions and may be contained in, for example, a product availability matrix.

At operation 220, an LLM is trained using the extracted entity and dependency information. At operation 230, a natural language query regarding a software program is received via a user interface. At operation 240, one or more entities in the natural language query is extracted. This may include using named entity recognition to perform or aid in the extraction.

At operation 250, supplemental information regarding the one or more entities in the natural language query is obtained from the one or more external sources. The type of supplemental information may be based on the natural language query. For example if the natural language query is concerned about compatibility, then the supplemental information could include current version numbers of relevant software programs. If the natural language query is concerned about impact of upgrading or downgrading a software product, then the supplemental information could include dependency information.

At operation 260, one or more prompts is generated based on the extracted one or more entities. This may include using, for example RAG. At operation 270, the one or more prompts is sent to the LLM.

At operation 280, one or more results is received from the LLM. At operation 290, a response to the natural language query is generated based on the one or more results. If multiple prompts were sent, then operation 290 may include combining the results of the multiple prompts into a report or chart.

In view of the disclosure above, various examples are set forth below. It should be noted that one or more features of an example, taken in isolation or combination, should be considered within the disclosure of this application. Example 1 is a system comprising: at least one hardware processor; and a computer-readable medium storing instructions that, when executed by the at least one hardware processor, cause the at least one hardware processor to perform operations comprising: using a natural language processor (NLP) application to extract entity and dependency information from data obtained from one or more external source, the data pertaining to software versions; training a large language model (LLM) using the extracted entity and dependency information; in response to receiving a natural language query regarding a software program via a user interface: extracting one or more entities in the natural language query; obtaining supplemental information regarding the one or more entities in the natural language query from the one or more external sources; generating one or more prompts based on the extracted one or more entities; sending the one or more prompts to the LLM; receiving one or more results from the LLM; and generating a response to the natural language based on the one or more results.

In Example 2, the subject matter of Example 1 includes, wherein the extracting is performed by utilizing named entity recognition (NER) to identify the one or more entities in the natural language query.

In Example 3, the subject matter of Examples 1-2 includes, wherein the one or more entities comprises a name of the software program.

In Example 4, the subject matter of Example 3 includes, wherein the supplemental information comprises a current version identifier for the software program.

In Example 5, the subject matter of Examples 3-4 includes, wherein the supplemental information comprises a release date for the software program.

In Example 6, the subject matter of Examples 3-5 includes, wherein the supplemental information comprises compatibility information for the software program.

In Example 7, the subject matter of Examples 1-6 includes, wherein the generating comprises retrieval augmented generation.

In Example 8, the subject matter of Examples 1-7 includes, wherein the one or more external source comprises a database.

In Example 9, the subject matter of Examples 1-8 includes, wherein the generating comprises generating one or more prompts designed to cause the LLM to generate information on other software program versions compatible with the software program.

In Example 10, the subject matter of Examples 1-9 includes, wherein the generating comprises generating one or more prompts designed to cause the LLM to generate information on impact, on other software program versions, of upgrading or downgrading the software program to a different version. Example 11 is a method comprising: using a natural language processor (NLP) application to extract entity and dependency information from data obtained from one or more external source, the data pertaining to software versions; training a large language model (LLM) using the extracted entity and dependency information; in response to receiving a natural language query regarding a software program via a user interface: extracting one or more entities in the natural language query; obtaining supplemental information regarding the one or more entities in the natural language query from the one or more external sources; generating one or more prompts based on the extracted one or more entities; sending the one or more prompts to the LLM; receiving one or more results from the LLM; and generating a response to the natural language based on the one or more results.

In Example 12, the subject matter of Example 11 includes, wherein the extracting is performed by utilizing named entity recognition (NER) to identify the one or more entities in the natural language query.

In Example 13, the subject matter of Examples 11-12 includes, wherein the generating comprises retrieval augmented generation.

In Example 14, the subject matter of Examples 11-13 includes, wherein the one or more external source comprises a database.

In Example 15, the subject matter of Examples 11-14 includes, wherein the generating comprises generating one or more prompts designed to cause the LLM to generate information on other software program versions compatible with the software program.

In Example 16, the subject matter of Examples 11-15 includes, wherein the generating comprises generating one or more prompts designed to cause the LLM to generate information on impact, on other software program versions, of upgrading or downgrading the software program to a different version.

Example 17 is a non-transitory machine-readable medium storing instructions which, when executed by one or more processors, cause the one or more processors to perform operations comprising: using a natural language processor (NLP) application to extract entity and dependency information from data obtained from one or more external source, the data pertaining to software versions; training a large language model (LLM) using the extracted entity and dependency information; in response to receiving a natural language query regarding a software program via a user interface: extracting one or more entities in the natural language query; obtaining supplemental information regarding the one or more entities in the natural language query from the one or more external sources; generating one or more prompts based on the extracted one or more entities; sending the one or more prompts to the LLM; receiving one or more results from the LLM; and generating a response to the natural language based on the one or more results.

In Example 18, the subject matter of Example 17 includes, wherein the extracting is performed by utilizing named entity recognition (NER) to identify the one or more entity in the natural language query.

In Example 19, the subject matter of Examples 17-18 includes, wherein the generating comprises generating one or more prompts designed to cause the LLM to generate information on other software program versions compatible with the software program.

In Example 20, the subject matter of Examples 17-19 includes, wherein the generating comprises generating one or more prompts designed to cause the LLM to generate information on impact, on other software program versions, of upgrading or downgrading the software program to a different version.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

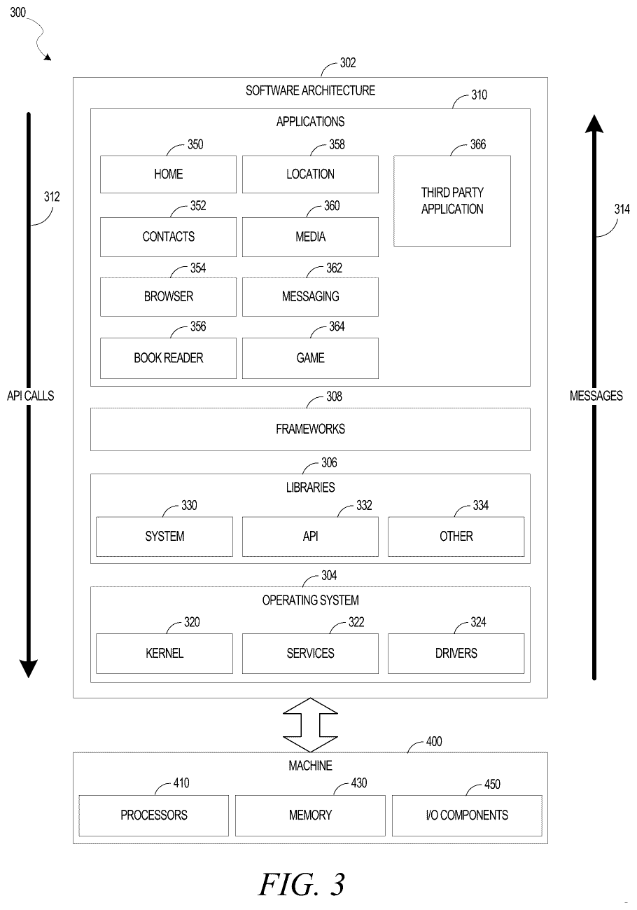

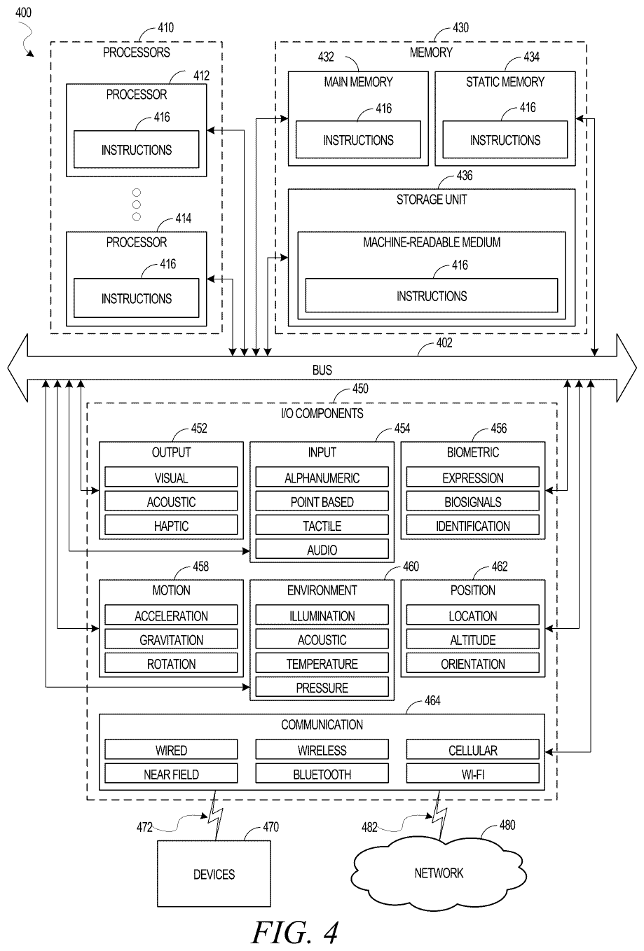

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics [PNG]), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various GUI functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 and send messages 314 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method 200 of FIG. 2. Additionally, or alternatively, the instructions 416 may implement FIGS. 1-2 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (e.g., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
using a natural language processor (NLP) application to extract entity and dependency information from data obtained from one or more external source, the data pertaining to software versions;
training a large language model (LLM) using the extracted entity and dependency information;
in response to receiving a natural language query regarding a software program via a user interface:
extracting one or more entities in the natural language query;
obtaining supplemental information regarding the one or more entities in the natural language query from the one or more external sources;
generating one or more prompts based on the extracted one or more entities;
sending the one or more prompts to the LLM;
receiving one or more results from the LLM; and
generating a response to the natural language based on the one or more results.

2. The system of claim 1, wherein the extracting is performed by utilizing named entity recognition (NER) to identify the one or more entities in the natural language query.

3. The system of claim 1, wherein the one or more entities comprises a name of the software program.

4. The system of claim 3, wherein the supplemental information comprises a current version identifier for the software program.

5. The system of claim 3, wherein the supplemental information comprises a release date for the software program.

6. The system of claim 3, wherein the supplemental information comprises compatibility information for the software program.

7. The system of claim 1, wherein the generating comprises retrieval augmented generation.

8. The system of claim 1, wherein the one or more external source comprises a database.

9. The system of claim 1, wherein the generating comprises generating one or more prompts designed to cause the LLM to generate information on other software program versions compatible with the software program.

10. The system of claim 1, wherein the generating comprises generating one or more prompts designed to cause the LLM to generate information on impact, on other software program versions, of upgrading or downgrading the software program to a different version.

11. A method comprising:
using a natural language processor (NLP) application to extract entity and dependency information from data obtained from one or more external source, the data pertaining to software versions;
training a large language model (LLM) using the extracted entity and dependency information;
in response to receiving a natural language query regarding a software program via a user interface:
extracting one or more entities in the natural language query;
obtaining supplemental information regarding the one or more entities in the natural language query from the one or more external sources;
generating one or more prompts based on the extracted one or more entities;
sending the one or more prompts to the LLM;
receiving one or more results from the LLM; and
generating a response to the natural language based on the one or more results.

12. The method of claim 11, wherein the extracting is performed by utilizing named entity recognition (NER) to identify the one or more entities in the natural language query.

13. The method of claim 11, wherein the generating comprises retrieval augmented generation.

14. The method of claim 11, wherein the one or more external source comprises a database.

15. The method of claim 11, wherein the generating comprises generating one or more prompts designed to cause the LLM to generate information on other software program versions compatible with the software program.

16. The method of claim 11, wherein the generating comprises generating one or more prompts designed to cause the LLM to generate information on impact, on other software program versions, of upgrading or downgrading the software program to a different version.

17. A non-transitory machine-readable medium storing instructions which, when executed by one or more processors, cause the one or more processors to perform operations comprising:
using a natural language processor (NLP) application to extract entity and dependency information from data obtained from one or more external source, the data pertaining to software versions;
training a large language model (LLM) using the extracted entity and dependency information;
in response to receiving a natural language query regarding a software program via a user interface:
extracting one or more entities in the natural language query;
obtaining supplemental information regarding the one or more entities in the natural language query from the one or more external sources;
generating one or more prompts based on the extracted one or more entities;
sending the one or more prompts to the LLM;
receiving one or more results from the LLM; and
generating a response to the natural language based on the one or more results.

18. The non-transitory machine-readable medium of claim 17, wherein the extracting is performed by utilizing named entity recognition (NER) to identify the one or more entities in the natural language query.

19. The non-transitory machine-readable medium of claim 17, wherein the generating comprises generating one or more prompts designed to cause the LLM to generate information on other software program versions compatible with the software program.

20. The non-transitory machine-readable medium of claim 17, wherein the generating comprises generating one or more prompts designed to cause the LLM to generate information on impact, on other software program versions, of upgrading or downgrading the software program to a different version.
